(19) United States
(12) Patent Application Publication
(10) Pub. No.: US 2019/0343054 A1
(43) Pub. Date: Nov. 14, 2019

(54) APPARATUS AND METHOD FOR IRRIGATING PLANTS

(71) Applicant: Ryan Ayres, Randwick, New South Wales (AU)

(72) Inventor: Ryan Ayres, Randwick, New South Wales (AU)

(21) Appl. No.: 16/473,092

(22) PCT Filed: Dec. 22, 2017
(86) PCT No.: PCT/AU2017/051449

§ 371 Date: Jun. 24, 2019

(30) Foreign Application Priority Data
Dec. 23, 2016 (AU) 2016905353
Sep. 18, 2017 (AU) 2017232031

(51) Int. Cl. A01G 27/00; F25B 21/02

(52) U.S. Cl. CPC A01G 27/003; F25B 21/02

(57) ABSTRACT

The present invention relates to an apparatus which is particularly designed to irrigate an indoor plant, such as a pot plant. The apparatus comprises a housing containing component which is arranged to be mounted in the pot plant's soil. The components include a Peltier device, which is arranged to condense water from ambient air, and a vibrating device arranged to vibrate a surface to facilitate water nm-off into the soil. The apparatus also includes a communication arrangement which is arranged to communicate with a remote device such as a smartphone or tablet. An application on the smartphone or tablet can be used to control the irrigation apparatus and also provide information on the status of the apparatus and the plant being irrigated to a user of the application.

### FIELD OF THE INVENTION

The present invention relates to an apparatus and method for irrigating plants and, particularly, but not exclusively, to an apparatus and method for irrigating pot plants.

### BACKGROUND OF THE INVENTION

With the increase in high density living, there is a greater requirement for indoor planting systems to beautify the home and provide a desirable environment. Indoor plants are also popular in the work/office environment.

The maintenance of indoor plants can be time consuming and difficult to keep up, particularly for busy people. Hiring persons externally to maintain the plants (e.g. in the work environment) can be expensive.

Indoor irrigation systems are known but are typically complex to set up and costly. They require multiple parts and connections and sometimes require expertise to install.

Most indoor irrigation systems require an external water source, which is often difficult to find inside a building.

U.S. Pat. No. 5,634,342 (John Peeters) discloses a device for watering a pot plant which can be placed in the soil within a plant pot. A Peltier module extracts ambient air moisture and supplies condensed water to the pot plant soil from a cold-side plate of the Peltier module. A moisture sensor is used to monitor moisture content of the soil and a micro controller is used to control the operation of the Peltier device.

There is a need for an improved method and apparatus for watering plants, particularly domestic pot plants.

### SUMMARY OF THE INVENTION

In accordance with a first aspect, the present invention provides an apparatus for irrigating a plant, comprising a device for obtaining water from ambient air, a substrate on which the water is condensed, and a vibrator mechanism for vibrating the substrate to facilitate water run-off from the substrate for delivery to soil for irrigating a plant.

In an embodiment, the apparatus comprises a controller for controlling the device for obtaining water. The controller may operate to switch the device on or off or otherwise regulate the device so the amount of water obtained can be controlled. The controller may also control the vibrator mechanism to turn it on or off for delivery of water to the soil.

In an embodiment, the apparatus comprises a moisture sensor for determining the moisture levels of the soil. In an embodiment, if the controller determines that the moisture of the soil is not optimum it can control the device for obtaining water to cause more water to be obtained from the ambient atmosphere in order to water the plant(s).

In an embodiment, the apparatus includes a communications arrangement to communicate with a remote device. Data may be provided by the apparatus to the remote device, relating to information on operation of the apparatus. For example, moisture levels of the soil, status of the device for obtaining water, and other information. In an embodiment, remote control may be applied via the remote device to control the apparatus. The remote device may comprise a computer , tablet, smartphone or any other remote device. Control instructions may be provided for the remote device to enable control of the apparatus and to receive information from the apparatus. The apparatus may be remote controlled to replicate the provision of water to the plant. The control instructions may be in the form of a software application.

In an embodiment, the apparatus comprises a housing mounting the device for obtaining water, the housing comprising a plurality of prongs which are arranged to be positioned within soil to secure the apparatus with respect to the soil and plant. In an embodiment, there are three prongs in tripod form. In an embodiment, the device is enclosed within walls of the housing. In another embodiment the may be a single prong, or two prongs.

In an embodiment, the device for obtaining water is a Peltier device. In an embodiment, a fan is also provided within the housing to draw air through the Peltier device.

In accordance with the second aspect, the present invention provides a method of irrigating plants, comprising the steps of obtaining water from ambient air by condensing water on a substrate, and vibrating the substrate to facilitate delivery of water to the plant(s).

In an embodiment, the plants are domestic plants.

In an embodiment, the substrate is positioned proximate soil mounting a plant. The substrate may be positioned within a plant pot. The substrate may be vibrated automatically.

In accordance with a third aspect, the present invention provides a system for irrigating plants, comprising an apparatus in accordance with the first aspect of the invention, together with a remote device arranged for remote communication with the apparatus.

The remote device may send and receive information to and from the apparatus.

The remote device may comprise a smartphone, computer, tablet or other device which is programmed with appropriate application software for communicating with the apparatus.

In accordance with the a fourth aspect, the present invention provides an apparatus for irrigating a plant, comprising a device for obtaining water from ambient air and comprising a substrate on which the water is condensed, and a communications arrangement for communicating with a remote device, whereby data can be communicated between the remote device and the apparatus for determining a status of the apparatus.

In an embodiment, the apparatus comprises a controller which is arranged to control the device for obtaining water. In an embodiment, the remote device can communicate with the controller for remote control of the device for obtaining water.

In an embodiment, the controller can communicate data to the remote device enabling the remote device to ascertain the status of the apparatus and also information relating to the status of soil/plant being irrigated.

In accordance with a fifth aspect, the present invention provides a computing device, comprising a processor, a memory, and an operating system for implementing computer processes, a plant monitoring process arranged to exchange data with an apparatus in accordance with the first aspect or the fourth aspect of the present invention, for receiving information on the status of the apparatus.

In an embodiment, the process may be able to control the apparatus.

The computing device may comprise a computer/smartphone, tablet or any other device.

In accordance with a sixth aspect, the present invention provides a computer program, comprising instructions for controlling a computer to implement a device in accordance with the fifth aspect of the invention.

In accordance with a seventh aspect, the present invention provides a computer readable medium, providing a computer program in accordance with the sixth aspect.

In accordance with an eighth aspect, the present invention provides a computer media signal comprising a computer program in accordance with the sixth aspect of the invention.

In accordance with a ninth aspect, the present invention provides an apparatus for irrigating a plant, comprising a device for obtaining water from ambient air and comprising a substrate on which the water is condensed for provision to soil, a moisture sensor arranged to sense the moisture of the soil, and a controller arranged to control the device for obtaining water in dependence on the moisture of the soil.

In accordance with a tenth aspect, the present invention provides a method of irrigating domestic plants comprising the steps of obtaining water from ambient air by condensing the water on a substrate for delivery to soil, determining the moisture of the soil, and delivering water to the soil in dependence on the determined moisture reading

In accordance with an eleventh aspect, the present invention provides an apparatus for irrigating a plant, comprising a device for obtaining water from ambient air and comprising a substrate on which the water is condensed for provision to soil, a pH sensor arranged to sense the pH of the soil, and a controller arranged to control the device for obtaining water in dependence on the pH of the soil.

In accordance with a twelfth aspect, the present invention provides a method of irrigating domestic plants comprising the steps of obtaining water from ambient air by condensing the water on a substrate for delivery to soil, determining the pH of the soil, and delivering water to the soil in dependence on the determined pH.

### BRIEF DESCRIPTION OF THE DRAWINGS

Features and advantages of the present invention will become apparent from the following description of embodiments thereof, by way of example only, with reference to the accompanying drawings, in which;

FIG. 1 is a front perspective view of an apparatus in accordance with an embodiment of the present invention;

FIG. 2 is a rear perspective view of the apparatus of FIG. 1;

FIG. 3 is a an exploded view of the apparatus of FIG. 1, showing internal components;

FIG. 4 is an illustration showing an apparatus of the embodiment of FIG. 1 in position in relation to a pot plant;

FIG. 5 is a block circuit diagram of components of the apparatus of the embodiment of FIG. 1,

FIG. 6 through 9 are “screen shots” of interfaces produced by a remote device arranged to interface with an apparatus such as illustrated in FIGS. 1 to 4;

FIG. 10 is an outline sectional view of the apparatus of FIG. 1, illustrating water outlets;

FIG. 11 is a view from the underside of the apparatus of FIGS. 1; and

FIG. 12 is a part sectional view of components of the apparatus of FIG. 1.

### DETAILED DESCRIPTION OF EMBODIMENTS

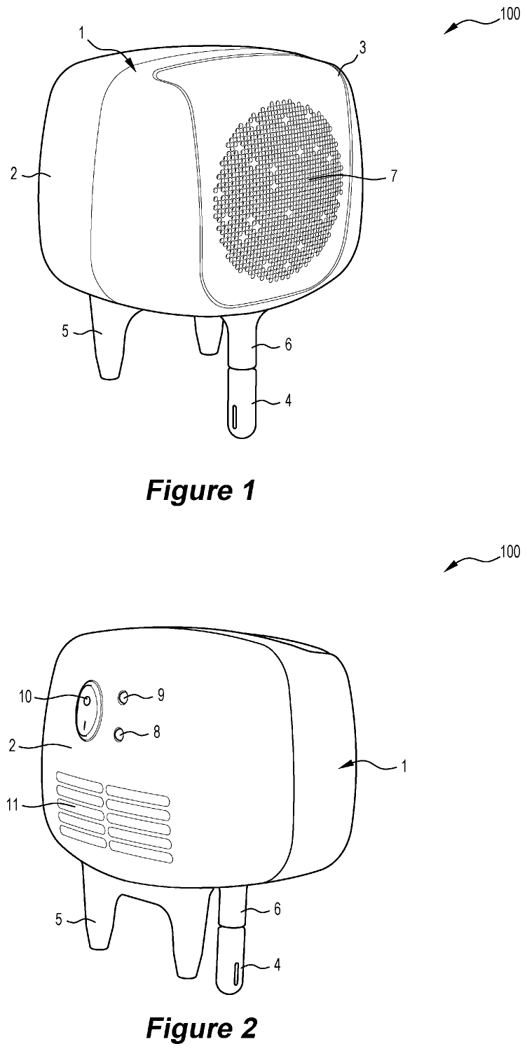

An apparatus in accordance with an embodiment of the present invention is illustrated in FIGS. 1 to 4.

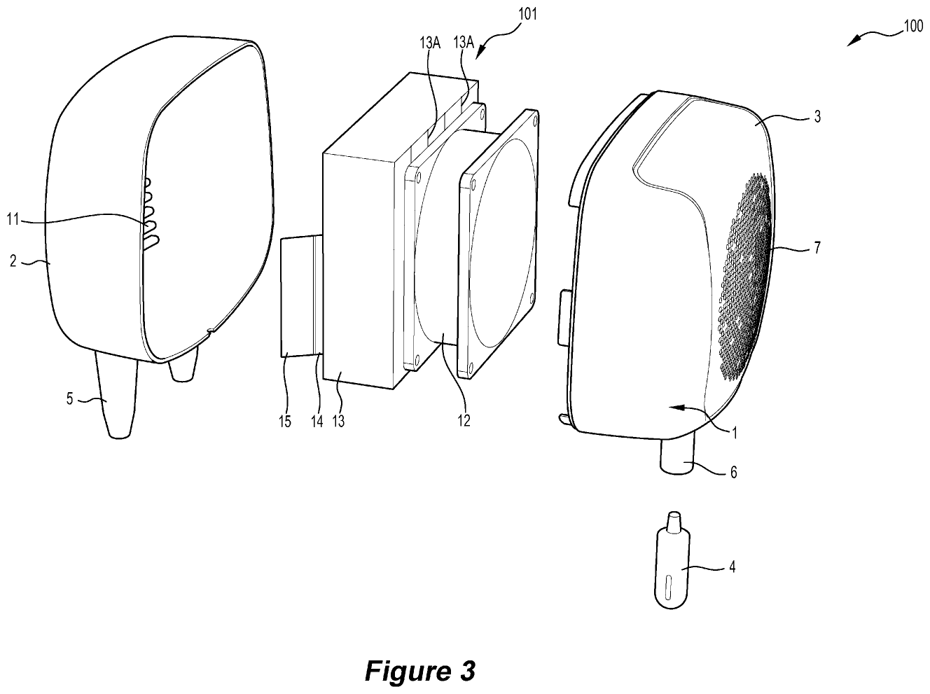

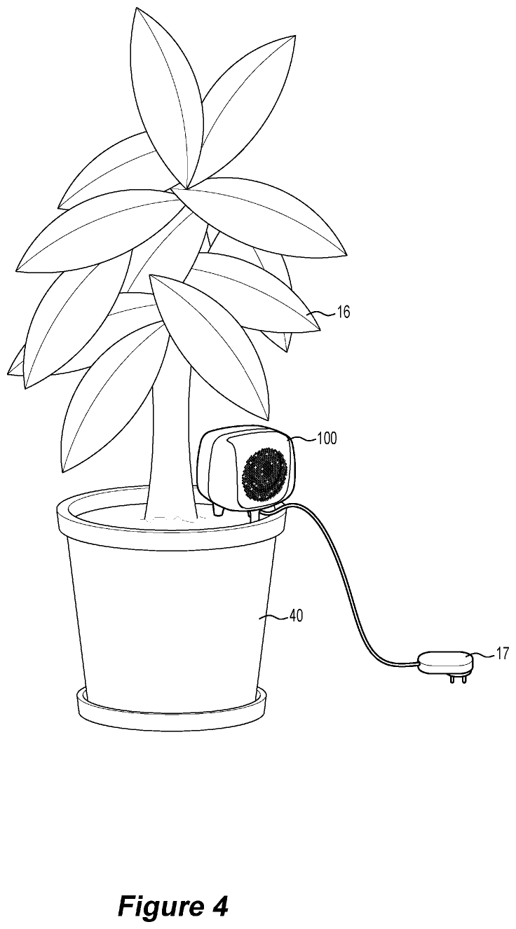

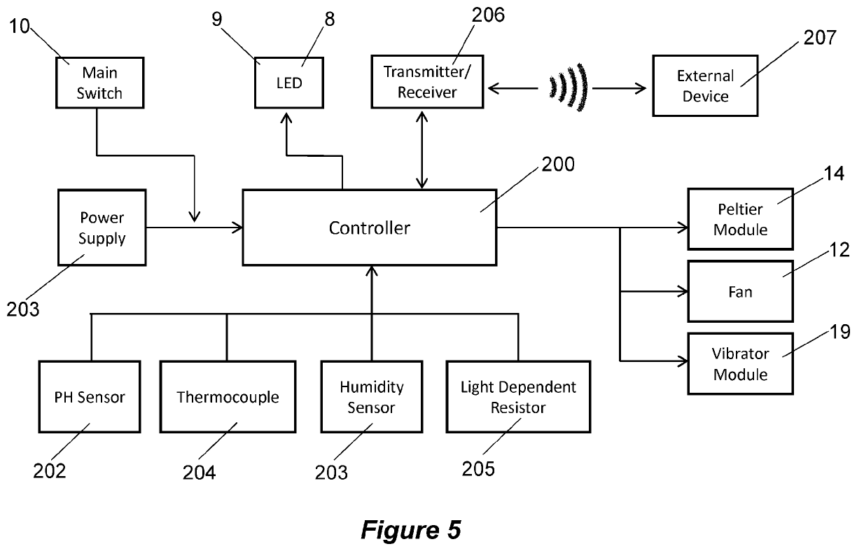

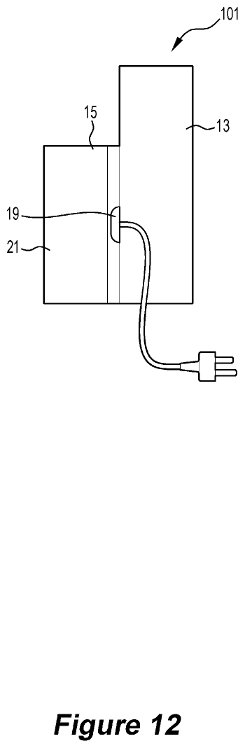

The apparatus, generally designated by reference numeral 100, comprises a device 101 (FIG. 3) for obtaining water from ambient air. The device 101, in this example, comprises a Peltier Cooling Module 101, which includes a substrate 15 in the form of a metal plate(s), in this example, on which water is condensed. A vibrator mechanism 19 (FIG. 5 and FIG. 12) is mounted with respect to the substrate 15. The vibrator mechanism 201 operates to vibrate the substrate 15 and condensing plates 21 (FIG. 12) and facilitate delivery of water from the substrate 15 and condensing plates 21 to soil which the apparatus 100 may be mounted in.

In more detail, in this embodiment, the device for obtaining water 101 comprises a Peltier device 14, a heat sink 101 and a fan arrangement 12 for drawing air through the heat sink 101 and Peltier device 14. In operation, the Peltier device 14 works by creating a temperature difference due to an applied voltage between two electrodes connected via a semi-conductor material.

Condensing plates 21 are mounted to the cool side of the Peltier device which cools the plate 15. Water from ambient air passing over the plates 21 is condensed.

The heat sink 13 is mounted to the hot side of the Peltier device 14. The heat sink 13 is a passive heat exchanger and designed to disperse the heat generated from the device. The heat sink 13 includes a number of vanes 13a to increase surface area.

The fan 12 is a 12 volt dc brushless axial cooling fan. It facilitates extraction of heat. Fan 12 is directly mounted to the heat sink to ensure the heat sink remains cool. Fan 12 also operates to pull air through the device over the cooling plate 15 and through the heat sink 13.

The vibrator mechanism 19 comprises a vibrator component 19 attached proximate the substrate and condensing plates 15/21. It is designed to vibrate the condensing plates 121 and disperse the water droplets gravitationally to the soil. The vibrator mechanism 19 consists of a module having a micro brush motor and an offset weight to provide the vibrating effect. It is powered by a three volt supply. The vibrator mechanism 19 facilitates delivery of water to the soil from the cooled substrate 15, 21.

The apparatus also comprises a controller 200 (FIG. 5) which is arranged to control the Peltier device 14 to turn it on and off in response to a determination as to whether water is required by the soil or not. Controller 200 also operates the vibrator module 19 and fan 12.

The device 101 is mounted in a housing, generally designated by reference numeral 1. The housing 1 comprises a rear casing 2 and a front casing 3. The front casing 3 includes a fan cap 7. The fan cap 7 is of mesh to allow air to be drawn through a rear casing vent 11 over the condensing plate(s) 21 via the heat sink 13 fan 12 and out through the front casing vent 7.

Only three components are required for the casing, being the rear cover 2, front cover 3 and fan vent 7 arrangement. All these components clip together easily.

The components 2, 3 of the housing are made from injection moulded plastics and have curved surfaces for appearance. The rear housing component 2 comprises two prongs 5 and the front housing component comprises one prong 6. When the housing 1 is assembled the three prongs 5, 6 form a tripod which can be fixed in a stable fashion in soil in a pot plant, for example (see FIG. 4).

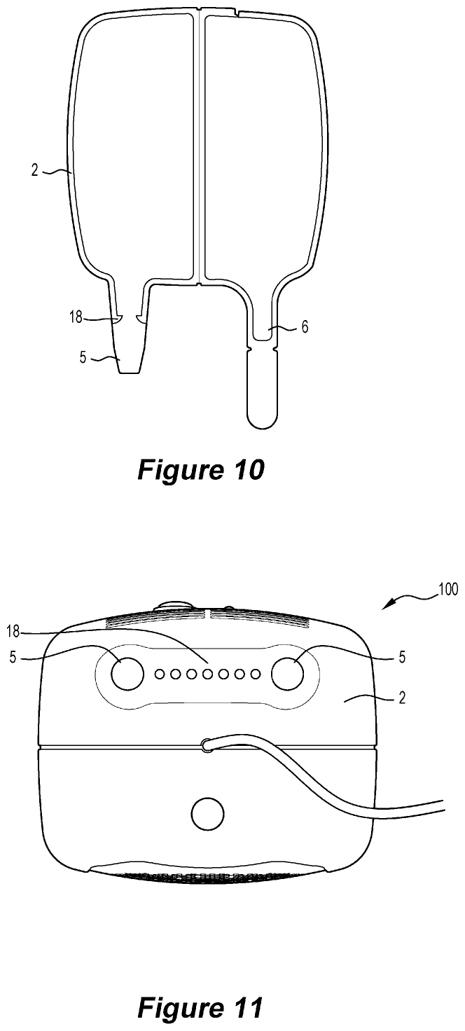

Referring to FIGS. 10 and 11, the base of the rear cover 2 is provided with a series of holes or a slot 18 between the rear prongs 5. Passageways through the rear cover 2 lead to the holes 18 and allow water to be dispensed over the soil quite widely from the condensing plates 21.

The front prong 6 has an extension part 4 which mounts a sensor. It may mount a number of sensors. In this embodiment, it mounts a moisture sensor 202 (FIG. 5) which can be used to determine the moisture of the soil. From this, the controller 200 is able to determine whether more or less water is is required to be delivered to the soil. The sensors may include a; capacitance probe sensor, pH sensor, neutron moisture sensor, a frequency domain sensor and/or a time domain transmission sensor.

In an alternative embodiment, only a single prong may be provided for the apparatus. The single prong may an equivalent to the front prong described above. In other embodiments, two or more prongs may be provided.

The rear component 2 also mounts LED indicators 8, 9 which are for indicating on/off the device (LED 9) and low soil moisture levels (LED 8).

The rear casing 2 also mounts a toggle switch 10 for switching the apparatus 100 on and off.

FIG. 4 shows the device 100 in position in a pot plant. The three prongs, 5 6 are positioned within the soil of the pot plant holder 18 in order to hold the device in a stable fashion. A power cord 17 is provided to enable power to the power supply 203 in the device (FIG. 5). In operation, the Peltier Cooling Module 101 operates to obtain water from the ambient air via condensation on plate 21. The vibrator arrangement 19 facilitates delivery of water from the plate(s) 21 via the passageways and holes or slot 18 into the soil of the pot plant 40, therefore maintaining the appropriate conditions for the plant 16. The apparatus 100 operates to maintain the plant and the appropriate soil water content. This obviates any requirement for the user to manually water the plant 16.

Referring to FIG. 5, the controller 200 is able to control all aspects of operation of the apparatus 100. Inputs to the controller 200 include the moisture sensor 202. When the moisture sensor detects that the moisture of the soil is too low, the controller may determine that further water is needed and may activate the Peltier device 14, fan 12 and vibrator module 19. The vibrator module 19 may be actuated intermittently.

As well as the moisture sensor 202 the apparatus 100 may include further sensors. A humidity sensor 203 can be used to control the apparatus based on the humidity and the ambient atmosphere. Humidity data may be sent to the user. A thermocouple 204 can be used to measure temperature and this information can be used for control and to be sent to the user. Light dependent resister 205 can measure light intensity and this can be used to determine positioning of the pot plant either close to natural light or in the shade to optimise plant health. Again, this information can be sent to the user.

The apparatus includes communications module 206 which has wireless connectivity to communicate with a remote device 207. The remote device may be a smartphone, tablet computer or any other device having a processor, memory and an operating system for implementing software applications. The device 207 also comprises software application(s) in the form of a plant processing application which is arranged to communicate data with the apparatus 100. The apparatus 100 may forward to the device 207 information relating to humidity, temperature, light intensity, soil water content and other information. The remote device 207 may be able to control operation of the apparatus 100 remotely. For example, it may be able to switch the apparatus 100 on and off.

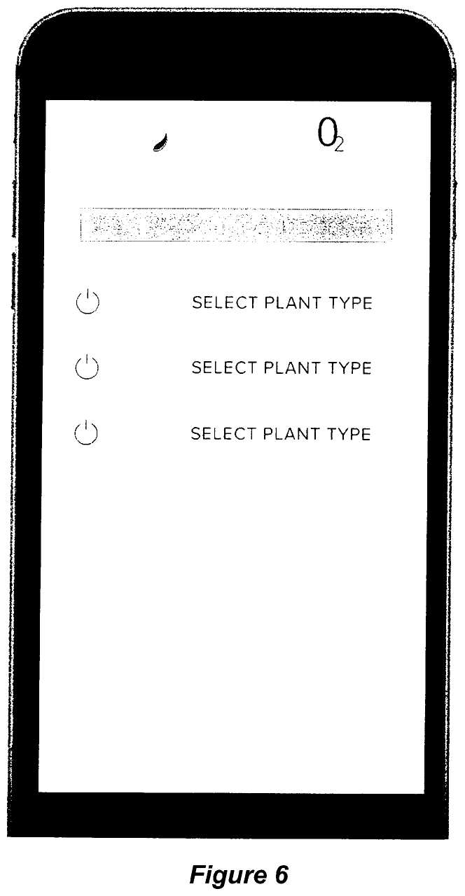

In this embodiment, the plant control process and the remote device 207 may be configured to control the apparatus 100 depending upon the type of plant. For example, (see FIG. 6) plant type may be selected and the apparatus 100 instructed to control the conditions of the pot plant depending on the plant type. For example, plant types that require more water may cause the controller 200 to operate the Peltier device 14 more often so that more water is added to the soil. Plants that do not require so much more water, the device may be controlled so that not so much water is provided.

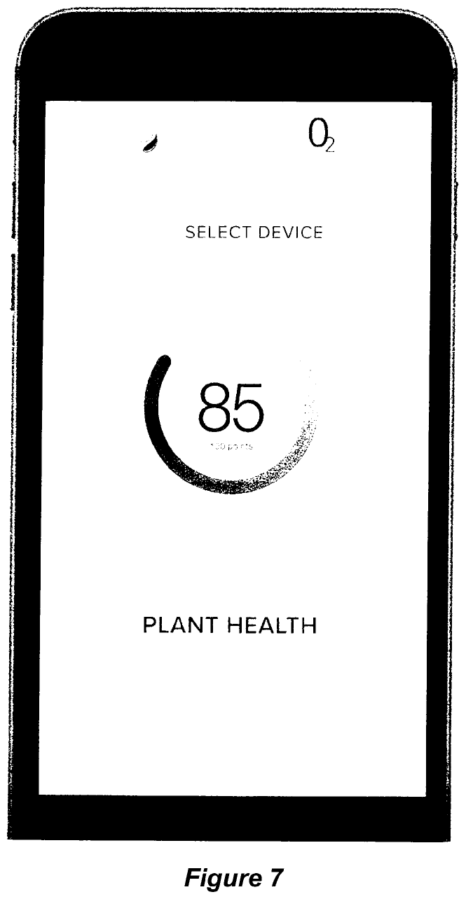

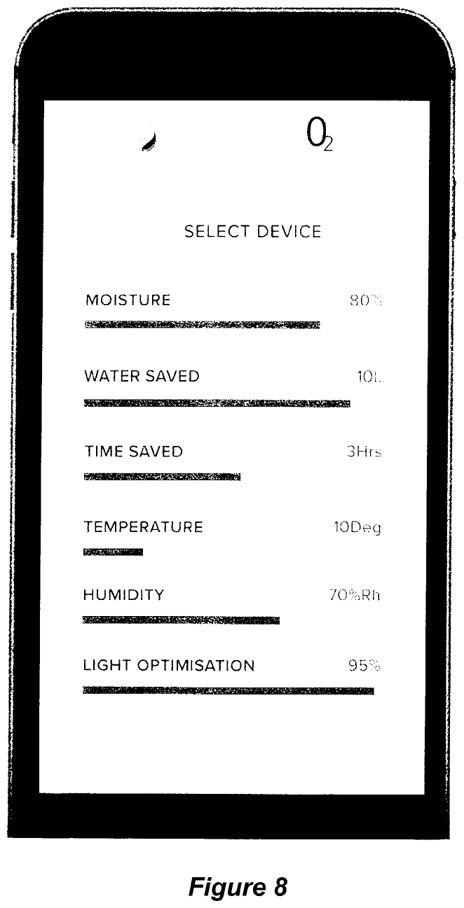

The process may also be able to determine plant health depending on algorithms incorporated in the process and the conditions determined by the sensors 202, 204, 203, 205. A “plant health” read out can be provided (FIG. 7). Calculations can be carried out to determine how much water has been saved by the highly controlled watering of the plant. The moisture content of the soil, temperature humidity and other information (see FIG. 8) and a display provided to the user.

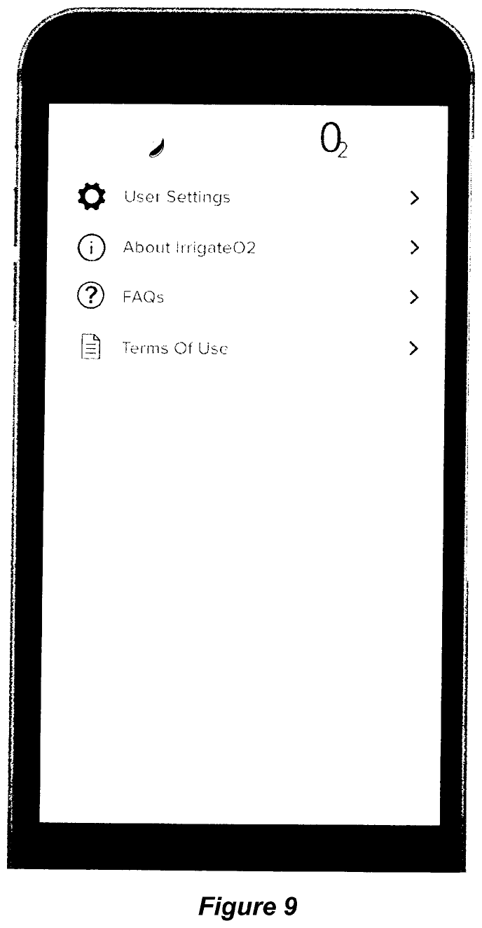

FIG. 9 shows a screen relating to user settings etc (home screen).

The apparatus 100 can be controlled by on/off switch 10 on the unit. Alternatively, it can be controlled by the process on an external device 207. Note that the process on the device 207 may be able to control multiple apparatus 100 (see “Add Device”) on FIG. 6. Managing several apparatus 100 at once can give control over numerous potted plants planter beds, etc.

Multiple apparatus 100 may be used in a system for watering plants in multiple plant pots or multiple plants in a planter bed.

The apparatus is not limited to maintenance of pot plants. Non domestic plants may be maintained by one or more apparatus.

Note that the apparatus may be differently sized depending upon the amount of water required.

In the embodiment described above a moisture sensor is used to determine the moisture level of the soil to determine whether more or less water is required to be delivered to the soil. Further embodiments include a pH sensor to measure the pH level of the soil. In embodiments including a pH sensor, the system determines whether more or less water is required to be delivered to the soil using the pH measurements. In some embodiments pH sensors are used in addition to a moisture sensor to detect the properties of the soil.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-22. (canceled)

23. An apparatus for irrigating a plant comprising a device for obtaining water from ambient air and comprising a substrate on which the water is condensed, and a vibrator mechanism for vibrating the substrate to facilitate water run-off from the substrate for delivery to soil for irrigating a plant.

24. An apparatus in accordance with claim 23, comprising a controller arranged to control the device to regulate the amount of water obtained.

25. An apparatus in accordance with claim 23, comprising a controller arranged to control the vibrator mechanism to regulate the delivery of water to the soil.

26. An apparatus in accordance with claim 24, comprising a moisture sensor for determining moisture levels of the soil, the controller being responsive to determination of moisture level to control the amount of water obtained and/or delivered to the soil.

27. An apparatus in accordance with claim 23, comprising a communications arrangement for communication with a remote device, communication including communicating data relating to information on operation of the apparatus.

28. An apparatus in accordance with claim 27, wherein the communications arrangement is arranged to receive control instructions from the remote device to control the apparatus.

29. An apparatus in accordance with claim 23, comprising a housing mounting the device for obtaining water, the housing comprising one or more prongs which are arranged to be positioned within the soil to secure the apparatus with respect to the soil and plant.

30. An apparatus in accordance with claim 23, wherein the device for obtaining water comprises a Peltier device and the apparatus further comprises a fan arranged to draw air through the Peltier device.

31. A method for irrigating domestic plants, comprising the steps of obtaining water from ambient air by condensing water on a substrate, and vibrating the substrate to facilitate delivery of water to the plant(s).

32. A computing device, comprising a processor, a memory, and an operating system for implementing computer processes, a plant monitoring process arranged to exchange data with an apparatus in accordance with claim 23, for receiving information on the status of the apparatus.

33. A device in accordance with claim 32, wherein the plant monitoring process is arranged to control the apparatus by way of data to the apparatus.
